(19) United States
(12) Patent Application Publication
(10) Pub. No.: US 2023/0292949 A1
(43) Pub. Date: Sep. 21, 2023

(54) AUTOMATED BREWING SYSTEM

(71) Applicant: Unique Bavarian Brewery, LLC, Castle Pines, CO (US)

(72) Inventors: Wilhelm Anthony Trappe, Vienna (AT); Tom Moorhead, Castle Pines, CO (US)

(21) Appl. No.: 18/186,939

(22) Filed: Mar. 20, 2023

Related U.S. Application Data
(60) Provisional application No. 63/321,479, filed on Mar. 18, 2022.

(51) Int. Cl. A47J 31/00; A47J 31/52

(52) U.S. Cl. CPC A47J 31/002; A47J 31/525; A47J 31/007

(57) ABSTRACT

Aspects of the present disclosure relate to an automated brewing system. In examples, a brewing system includes a variety of brewing components (e.g., one or more tanks, pumps, heaters, chillers, and/or sensors) and an associated brewing controller that manages operation of the brewing components. The brewing system may include an operator device that is in communication with the brewing controller and obtains one or more recipes (e.g., from a brewing platform) to be performed by the brewing system, thereby at least partially automatically brewing liquid based on the recipe accordingly. A user device may enable a user to browse recipes of the brewing platform, view the status of the brewing system, and/or control the brewing system, among other examples.

### CROSS-REFERENCE TO RELATED APPLICATION

This application claims priority to U.S. Provisional Application No. 63/321,479, titled “Brewing System,” filed on Mar. 18, 2022, the entire disclosure of which is hereby incorporated by reference in its entirety.

### BACKGROUND

Brewing beverages, for example brewing beer, is typically a laborious process that has several individually conducted steps and large equipment for conducting these steps. One or more qualified brewing technicians and cleaning staff may similarly be involved. These and other aspects of a traditional brewing process may result in a high barrier to entry, may result in increased resource utilization (e.g., expense, time, and/or capital), and may result in beverages having reduced quality, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to an automated brewing system. In examples, a brewing system includes any of a variety of brewing components (e.g., one or more tanks, pumps, heaters, chillers, and/or sensors) and an associated brewing controller that manages operation of the brewing components. The brewing system may include an operator device that is in communication with the brewing controller and obtains one or more recipes (e.g., from a brewing platform) to be performed by the brewing system, thereby at least partially automatically brewing liquid based on the recipe accordingly. A user device may enable a user to browse recipes of the brewing platform, view the status of the brewing system, and/or control the brewing system, among other examples.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which an automated brewing system according to aspects described herein may be used.

FIG. 2 illustrates an overview of an example process flow between a user device, a brewing platform, an operator device, and a brewing controller according to aspects described herein.

FIG. 3 illustrates an overview of an example method for operating a brewing system based on a recipe according to aspects described herein.

FIG. 4 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present disclosure relate to an automated brewing system. In examples, a brewing system includes any of a variety of brewing components (e.g., one or more tanks, pumps, heaters, chillers, and/or sensors) and an associated brewing controller. The brewing controller manages operation of the brewing components, such that the brewing components are operated, at least partially automatically, to brew any of a variety of liquids (e.g., beer or liquor). In examples, the brewing system further comprises an operator device that is in communication with the brewing controller. In examples, a user device functions as the operator device, such that the brewing system need not include the operator device. As another example, the brewing controller implements similar functionality to the operator device according to aspects described herein.

The operator device may obtain or otherwise access one or more recipes (e.g., from a brewing platform), where a recipe includes a set of operations to be performed by the brewing system (e.g., as may be managed by the brewing controller). In some examples, a user operates a user device to browse a library of recipes (e.g., from the brewing platform), such that the user may select a recipe for execution by the brewing system. In response to the user selection, the brewing system obtains the recipe and begins brewing liquid based on the recipe accordingly. In examples, the brewing platform generates an indication to dispatch a set of ingredients associated with the recipe, such that the set of ingredients is received by the user for use with the brewing system when implementing the recipe.

As an example, a recipe includes a set of operations to: fill a first and/or second tank with an amount of liquid; heat and hold the first tank to a specified temperature; cool and hold the second tank to a specified temperature; pump at a specified speed from at least one of the first tank or the second tank to at least one of an arm and/or spray ball of the first tank, an arm and/or spray ball of the second tank, a waste outlet, or a liquid output outlet; open and/or close a lid of the first tank and/or the second tank; and wait until a timer has elapsed for a given operation. It will be appreciated that such operations are provided as examples and, in other examples, additional, fewer, and/or alternative operations may be used. For instance, the above operations may form a recipe to brew beer and/or may be used in a cleaning/sterilization recipe, among other examples.

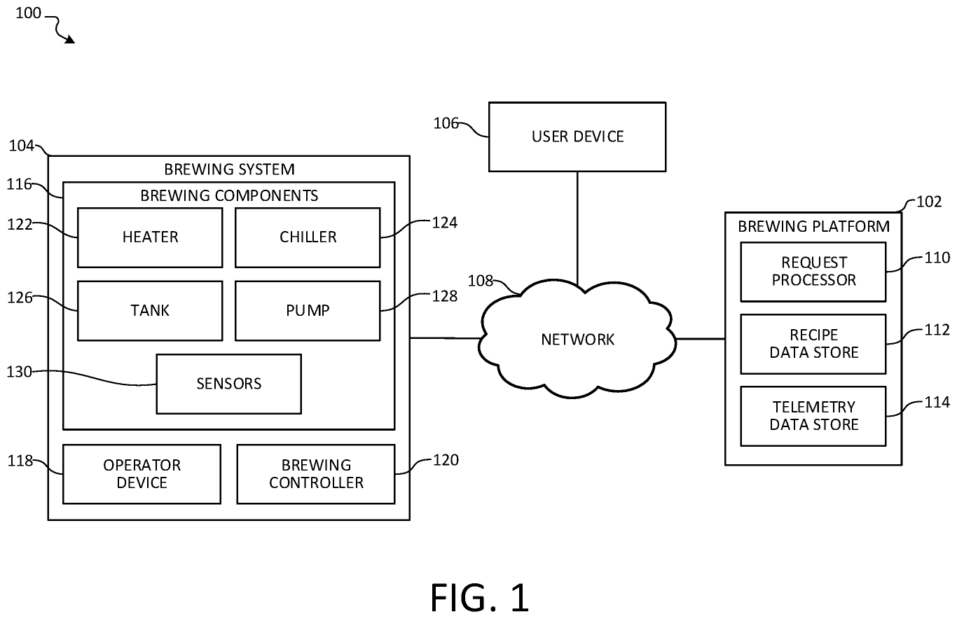

FIG. 1 illustrates an overview of an example system 100 in which an automated brewing system 104 according to aspects described herein may be used. As illustrated, system 100 includes brewing platform 102, brewing system 104, user device 106, and network 108. In examples, brewing platform 102, brewing system 104 (e.g., operator device 118 and/or brewing controller 120), and/or user device 106 communicate via network 108, which may comprise a local area network, a wireless network, or the Internet, or any combination thereof, among other examples. Additionally, or alternatively, brewing system 104 and user device 106 communicate via a direct connection (e.g., Bluetooth, Bluetooth Low Energy, and/or Wi-Fi Direct). In such an example, user device 106 may act as a gateway for brewing system 104, such that user device 106 relays communication between brewing system 104 and brewing platform 102, among other examples.

As illustrated, brewing system 104 includes brewing components 116, operator device 118 and brewing controller 120. Brewing components 116 includes heater 122, chiller 124, tank 126, pump 128, and sensors 130. It will be appreciated that the illustrated components are provided for illustrative purposes and that additional, fewer, and/or alternative components may be used in other examples (e.g., various actuators, agitators, and/or rotary arms). For instance, while brewing components 116 is illustrated as having a single tank 126, two or more tanks may be used in other examples. In examples, heater 122 and chiller 124 are used to heat or cool the content of tank 126. Pump 128 may be used to fill tank 126 (e.g., from an external source, such as from another tank or from a water source), may be used to circulate the content of tank 126 (e.g., by pumping liquid from a bottom of tank 126 to a top of tank 126), and/or may be used to pump liquid out of tank 126 (e.g., to another tank and/or to an outlet of brewing system 104), among other examples.

Sensors 130 are included to provide various data relating to brewing system 104, which is processed by brewing controller 120 according to aspects described herein. Example sensors include, but are not limited to, a temperature sensor, a fluid level sensor (e.g., a time-of-flight sensor or a contact sensor), a flow sensor, a hydrometer, an acidity sensor, and/or a pressure sensor. Accordingly, brewing controller 120 monitors data from sensors 130 and operates heater 122, chiller 124, and/or pump 128 to brew liquid corresponding to a recipe according to aspects described herein.

For example, brewing controller 120 implements various commands, for example in firmware, that are thus usable by operator device 118. For example, brewing controller 120 implements a fill command (e.g., to fill tank 126 with water and/or with liquid from another tank), a temperature command (e.g., to heat/cool the content of tank 126), a hold command (e.g., to ferment the content of tank 126 and/or to maintain operation of brewing components 116 according to a set of parameters), and a pump command (e.g., to operate pump 128). While example commands are described, it will be appreciated that additional, fewer, and/or alternative commands may be implemented in other examples.

Brewing controller 120 generates telemetry data, which may be provided to operator device 118 (e.g., to manage operation of brewing system 104 accordingly) and/or to brewing platform 102 (e.g., for diagnostics, customer support, and/or service scheduling). For example, the telemetry data includes data obtained from sensors 130. As another example, the telemetry data includes an indication as to whether brewing system 104 is currently processing a recipe. Additionally, or alternatively, the telemetry data includes a status associated therewith, such as a percentage completion, one or more operation of a recipe that are currently being performed, and/or the most recently completed operation. It will therefore be appreciated that any of a variety of telemetry data may be generated by brewing controller 120. As another example, an indication for specific telemetry data is received by brewing controller 120 (e.g., from operator device 118 and/or brewing platform 102), such that brewing controller 120 generates the telemetry data accordingly.

As a further example, the telemetry data includes open/closed status for one or more lids, tank glycol temperature, tank content temperature, tank level reading, tank pressure reading, tank specific gravity reading, tank fill operation total liters, and/or whether one or more checkpoints have been reached for a given operation.

Thus, as a result of providing brewing controller 120, low-level implementation details of brewing system 104 may be managed by brewing controller 120, thereby providing a layer of abstraction between operator device 118 and brewing components 116. Thus, an operator device similar to operator device 118 may be used for any of a variety of other brewing systems, while at least some implementation-specific aspects may thus be handled by an associated brewing controller accordingly.

Brewing system 104 is further illustrated as including operator device 118. In examples, operator device 118 communicates with brewing controller 120 (e.g., via a wired/wireless communication, such as via a serial connection and/or a Bluetooth connection) to control operation of brewing system 104. For example, operator device 118 includes a screen via which to display a status of brewing system 104 and/or to enable a user to select a recipe or otherwise manage brewing system 104. Operator device 118 may include a touch screen, mouse, and/or keyboard with which to receive user input. In examples, operator device 118 includes communication hardware, for example for wireless and/or wired communication (e.g., via network 108 and/or with user device 106).

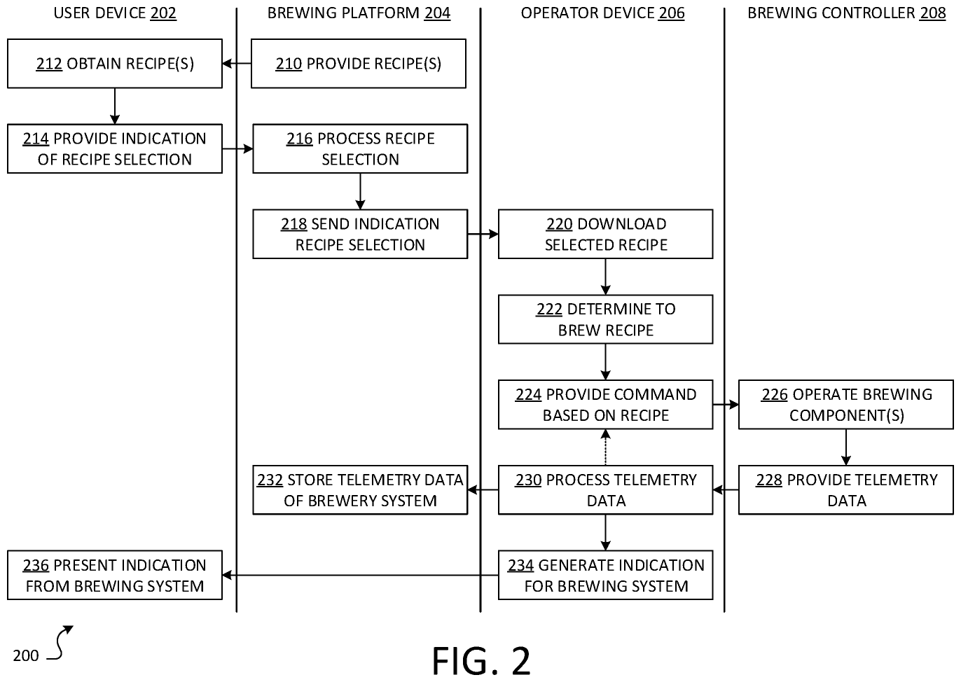

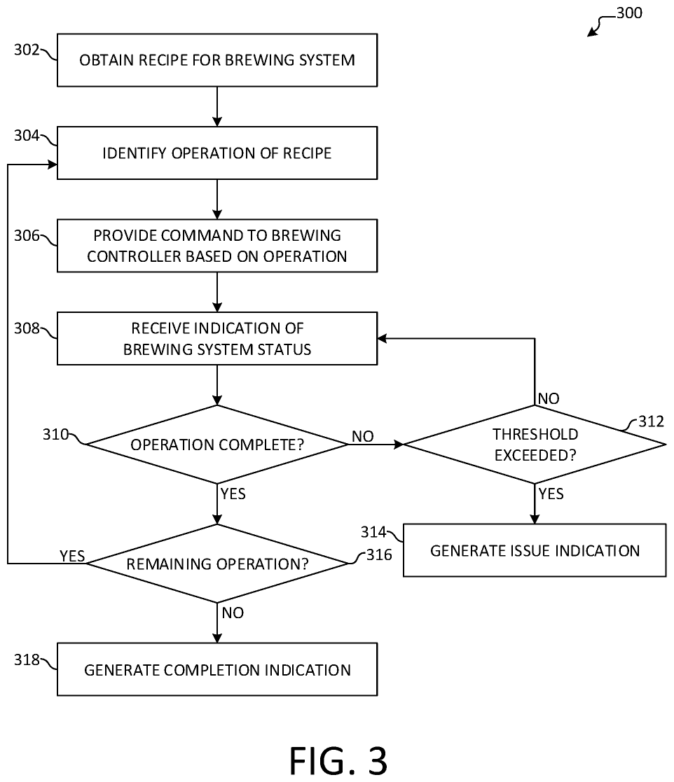

A user may browse recipes and/or select a recipe using operator device 118. In another example, a user selects a recipe via user device 106, such that brewing system 104 receives an indication of the recipe from user device 106 and/or via brewing platform 102, among other examples. As a result, operator device 118 processes the recipe and generates a set of commands that are processed by brewing controller 120 accordingly, thereby causing brewing components 116 to brew the specified liquid based on the recipe. Additional examples of such aspects are described below with respect to FIGS. 2 and 3.

While example aspects are described with respect to operator device 118, it will be appreciated that any of a variety of other input devices, components, and/or user experience paradigms may be used in other examples without departing from the spirit of this disclosure. Further, as noted above, other examples may include a brewing controller that implements various aspects of operator device 118 (e.g., thus omitting operator device 118), which may thus be controlled via user device 106 or functionality may be distributed across any of a variety of other devices, controllers, and/or platforms, among other examples.

As illustrated, brewing platform 102 includes request processor 110, recipe data store 112, and telemetry data store 114. As noted above, brewing platform 102 includes a library of recipes, which is stored by recipe data store 112. In examples, request processor 110 processes a request to list recipes of recipe data store 112 (e.g., as may be received from operator device 118 and/or user device 106), such that a corresponding set of recipes are provided for display to a user in response. In examples, the recipes are listed according to a category (e.g., a type of beer, a region, and/or based on one or more associated ingredients). A user may have a user account with which the user may associate one or more recipes as favorite recipes.

As used herein, a recipe defines a set of operations to be performed by a brewing system (e.g., brewing system 104) to produce a liquid (e.g., a lager, a stout, etc.) associated with the recipe. Further, some recipes need not produce a liquid, as may be the case for a cleaning or sterilization recipe, which similarly includes a set of operations for brewing system 104 to achieve a desired result. In some examples, an operation has one or more suboperations, each of which may be a serial suboperation or a parallel suboperation. In such examples, the operation may not be determined to be complete until each of the associated suboperations have been completed. Thus, such an operation may comprise performing multiple parallel suboperations before or after a serial suboperation, at which point the operation is determined to be complete (e.g., and a subsequent operation of the recipe can then be performed).

In some instances, an operation has an associated manual instruction, such that a user performs an action associated with the instruction. It may be determined that the manual instruction has been completed based on receiving a user indication that the action has been performed (e.g., via operator device 118 and/or user device 106) and/or based on sensor data indicating completion of the action, among other examples. In instances where the sensor data indicates the action has not been completed or has only partially been completed, the user may be prompted to continue the action and/or to take a remedial action, among other examples.

Each operation/suboperation may have an associated completion condition and/or timeout threshold. Example completion conditions include, but are not limited to, determining a period of time has elapsed, determining a certain temperature has been reached (e.g., as may be affected by heater 122 and/or chiller 124), determining a tank (e.g., tank 126) contains a certain volume, determining a pump (e.g., pump 128) has pumped a certain volume and/or achieved a certain flow, and/or determining an alcohol content of a tank has reached a certain threshold, among other examples. Similarly, a timeout threshold may correspond to such criteria, for example determining that a period of time has elapsed without reaching a certain temperature threshold or that a flow of a pump is below a certain threshold or outside of an acceptable range. Thus, it will be appreciated that completion conditions and/or timeout thresholds according to aspects described herein may, in some examples, correspond to one or more sensors of a brewing system (e.g., sensors 130 of brewing system 104).

Additionally, or alternatively, the user account of brewing platform 102 may have an associated record of recipes that the user has brewed (e.g., using brewing system 104). In examples, brewing platform 102 enables the user to order associated ingredients, to schedule recipes for brewing at a future date (e.g., such that an indication is generated to dispatch set of associated ingredients for receipt by the future date), and/or to mange a set of brewing systems that is associated with the user account. For example, each associated brewing system may include a location at which the device is located and/or a user-specified name, thereby enabling the user to distinguish between devices. In examples, a user provides an indication or otherwise selects a specific amount of liquid to be brewed, such that a set of ingredients is provided corresponding to the specific amount of liquid. Similarly, a recipe corresponding to the provided set of ingredients may thus be adapted according to the specific amount of liquid, such that the same recipe (e.g., from recipe data store 112) is usable to brew varying amounts of liquid (e.g., using brewing system 104) based on such a user indication.

Brewing platform 102 further includes telemetry data store 114. As noted above, brewing system 104 may provide telemetry data to brewing platform 102, which may be stored in telemetry data store 114. In examples, telemetry data is stored in association with a recipe for which the telemetry data was generated. In some examples, the recipe is further associated with a set of ingredients (e.g., a batch number, a quantity, etc.) that was provided (e.g., in response to user selection of the recipe as discussed above). Thus, brewing platform 102 may process the telemetry data, for example to troubleshoot issues, to provide data that is usable by a customer service representative, and/or to schedule service for brewing system 104.

For example, brewing platform 102 processes the telemetry data to identify an issue with brewing system 104. Brewing platform 102 provides an indication of the issue (e.g., to operator device 118 and/or user device 106), thereby alerting a user of the identified issue. Additionally, or alternatively, a user account may indicate that brewing system 104 is scheduled to brew a recipe at a future date, such that brewing platform 102 generates a service recommendation to have brewing system 104 serviced prior to the future date. For example, the service recommendation is generated based on scheduling availability of a service technician. The service recommendation may similarly be provided for display to a user, such that the user may accept the recommendation, select a different time/date, or decline the recommendation, among other examples. As another example, service for brewing system 104 may automatically be scheduled.

While example aspects are described with respect to brewing platform 102, it will be appreciated that any of a variety of alternative or additional functionality may be provided in other examples. For instance, brewing platform 102 may communicate with a point-of-sale terminal to provide business intelligence, inventory management, and/or reporting capabilities in association with one or more user accounts. Additionally, or alternatively, a user of brewing platform 102 may indicate to share data with other users, thereby granting the user access to data of other users accordingly. For instance, trends in demand, brewing, and/or ingredient availability may be aggregated by brewing platform 102 and provided for analysis by users, among other examples.

System 100 is further illustrated as including user device 106. As an example, user device 106 may be a mobile computing device, a tablet computing device, a laptop computing device, or a desktop computing device, among other examples. User device 106 may run an application associated with brewing platform 102 or may use a web browsing application to access a website of brewing platform 102. Accordingly, user device 106 enables a user to view a status of brewing system 104, such as whether the brewing system is brewing a recipe (e.g., including an estimated time of completion, a current step, and/or an instruction for the user to perform a manual operation associated with a recipe) and/or whether the brewing system needs maintenance, among other examples. As noted above, user device 106 may be used to browse a recipe catalog of brewing platform 102, manage favorite recipes, select a recipe for brewing, schedule a recipe, and/or order a set of ingredients associated with a recipe, among other examples. Additionally, or alternatively, user device 106 is used to present any of a variety of indications from brewing system 104 and/or brewing platform 102. In examples, an application of user device 106 incorporates similar functionality as was discussed above with respect to operator device 118, as may be the case when a brewing system is used that omits such an operator device.

FIG. 2 illustrates an overview of an example process flow 200 between user device 202, brewing platform 204, operator device 206, and brewing controller 208 according to aspects described herein. In examples, aspects of user device 202, brewing platform 204, operator device 206, and brewing controller 208 are similar to user device 106, brewing platform 102, operator device 118, and brewing controller 120, respectively, discussed above with respect to FIG. 1 and are therefore not necessarily redescribed in detail below. Operator device 206 and brewing controller 208 may each be part of a brewing system, such as brewing system 104.

As illustrated, process flow 200 begins at operation 210, where recipes are provided to user device 202. In examples, the recipes are provided from a recipe data store, such as recipe data store 112 in FIG. 1. The recipes may be provided in response to a request from user device 202, among other examples. As noted above, brewing platform 204 may filter available recipes according to an indicated category, among any of a variety of additional or alternative criteria (e.g., alcohol content, associated ingredients, etc.). While examples are described in which recipes are obtained from a brewing platform, it will be appreciated that any of a variety of other sources may be used. For instance, a removable storage device may be used to transfer a recipe to a brewing system (e.g., from a user device) or a device may wireless transmit the recipe to the brewing system, among other examples.

At operation 212, user device 202 obtains the recipes, which may be presented to a user, such that a user selection of one of the recipes is received. Accordingly, at operation 214, an indication of the selected recipe is provided to brewing platform 204. For example, the user may indicate that the recipe is to be brewed by a brewing system. As a result, at operation 216, brewing platform 204 processes the recipe selection. For example, brewing platform 204 updates a user account to indicate the brewing system is to brew the selected recipe. In examples, brewing platform 204 generates an indication to dispatch a set of ingredients associated with the selected recipe and/or determines the user already has one or more of the ingredients (e.g., from a previous ingredient shipment). In examples, operation 216 comprises scheduling the recipe for brewing, as may be the case when user input is received by user device 202 that indicates a future date.

Flow 200 progresses to operation 218, where an indication of the recipe selection is sent to operator device 206 of the brewing system. In examples, operation 218 occurs sometime after operation 216, as may be the case when a set of ingredients are first delivered for use with the brewing system. Accordingly, at operation 220, operator device 206 downloads the selected recipe. In other examples, operation 220 is omitted, as may be the case when the brewing system has already brewed the recipe in the past, among other examples.

At operation 222, it is determined to brew the recipe. For example, it may automatically be determined to brew the recipe, for example as a result of determining the set of ingredients has been delivered and/or as a result of determining that the date is the future date that was indicated by the user, among other examples. As another example, an indication is received by operator device 206, such that it is determined to brew the recipe accordingly. For instance, the indication is received from brewing platform 204 and/or user device 202. As an example, a user may provide the indication via user device 202, for example by actuating a button or other user interface element associated with beginning brewing the recipe.

Flow progresses to operation 224, where a command is provided to brewing controller 208 based on the recipe, such that, at operation 226, brewing controller 208 operates one or more brewing components (e.g., brewing components 116 in FIG. 1) accordingly. As noted above, the recipe includes one or more operations, such that the provided command corresponds with an operation and/or suboperation of the recipe accordingly. Additional examples of such aspects are discussed below with respect to FIG. 3.

At operation 228, telemetry data is provided by brewing controller 208 to operator device 206. While flow 200 illustrates operation 228 as occurring sequentially to operation 226, it will be appreciated that telemetry data may be provided by brewing controller 208 periodically, in response to a request, in response to an event, and/or according to any of a variety of other control schemes. For example, the telemetry data is periodically provided by brewing controller 208 while operation 226 is being performed.

Moving to operation 230, the telemetry data is processed by operator device 206. For example, the telemetry data is processed to determine whether a completion condition and/or timeout threshold is met. In other examples, the telemetry data includes a success and/or failure indication, which is processed at operation 230 accordingly. In some examples, operation 230 comprises providing the telemetry data to brewing platform 204, such that it is stored (e.g., in a telemetry data store) by brewing platform 204 at operation 232. In instances where the recipe includes an additional operation, flow 200 returns to operation 230, as indicated by the dashed arrow. Thus, flow loops between operations 224, 226, 228, and 230 to perform the set of operations for the recipe, thereby producing liquid associated with the recipe accordingly. In instances where a timeout threshold is met and/or a failure indication is received from brewing controller 208, flow 200 may similarly instead branch to operation 234 (e.g., rather than completing the recipe).

Accordingly, at operation 234, an indication for the brewing indication is generated. For example, the indication is a success indication (e.g., in an instance where the recipe was completed) or a failure indication (e.g., in an instance where a timeout threshold was met or a failure occurred), among other examples. At operation 236, the indication is presented to a user of user device 202. The indication may be provided directly to user device 202 (e.g., via Bluetooth, Wi-Fi Direct, or a network connection) or may be relayed to user device 202 via brewing platform 204, among other examples.

It will be appreciated that process flow 200 is provided for illustrative purposes and, in other examples, additional, fewer, or alternative operations may be performed. For example, operator device 206 may provide an indication to user device 202 in an instance where the recipe includes a manual instruction for a user to perform an action. Such aspects may be similar to the aspects discussed above with respect to operations 234 and 236. Additionally, or alternatively, operator device 206 generates an alert (e.g., an audible alert and/or a visual alert) to provide such an indication to the user. Accordingly, in such an example, an indication of the manual instruction is presented via a display of operator device 206. Once the user has performed the action, flow 200 may continue looping between operations 224, 226, 228, and 230 according to aspects described herein.

FIG. 3 illustrates an overview of an example method 300 for operating a brewing system (e.g., brewing system 104 in FIG. 1) based on a recipe according to aspects described herein. In examples, aspects of method 300 are performed by an operator device, a brewing controller, and/or a user device, among other examples.

As illustrated, method 300 begins at operation 302, where a recipe is obtained for the brewing system. In examples, the recipe is obtained from a recipe data store, such as recipe data store 112 in FIG. 1. However, it will be appreciated that a recipe may be obtained from any of a variety of other sources, such as from a user device (e.g., wirelessly) and/or from a removable storage device, among other examples. In some instances, users may share recipes, for example using an electronic message or via a brewing platform, among other examples.

At operation 304, an operation of the recipe is identified. In examples, the set of operations defined by the recipe is sequential, such that operation 304 comprises identifying the first operation of the recipe. In some examples, the operation is identified based on determining one or more preceding operations have already been performed. For instance, an operation may comprise determining whether the brewing system is operational and/or evaluating the acidity of an available water source, among other examples.

Flow progresses to operation 306, where a command is provided to a brewing controller (e.g., brewing controller 120 or 208 in FIGS. 1 and 2, respectively). As described above, the brewing controller implements a set of commands with which a set of brewing components are controlled. Thus, the command provided at operation 306 corresponds to the operation that was identified at operation 304, thereby causing the brewing controller to operate the set of brewing components of the brewing system to achieve a specified state (e.g., a target temperature, a fill volume, an amount of fermentation, and/or a level of agitation/circulation). In examples, the identified operation includes the command or, as another example, operation 306 comprises processing the operation to generate the command. In some examples, the command is dynamically generated based on a current state of the brewing system and/or the operating environment, as may be the case when the operation is associated with ambient temperature or water pH, among other examples.

At operation 308, an indication of brewing system status is received. For example, operation 308 comprises obtaining telemetry data from the brewing controller, which may indicate a state of the brewing system according to aspects described herein. Additionally, or alternatively, operation 308 comprises receiving a success or a failure indication. For instance, operation 306 may comprise providing an indication of a completion condition and/or timeout threshold to the brewing controller, such that the brewing controller alternatively or additionally identifies when an operation has been completed.

Accordingly, at determination 310, it is determined whether the operation is complete. For example, determination 310 comprises evaluating telemetry data that was obtained at operation 308 to determine whether a completion condition has been met. As another example, determination 310 comprises determining whether a success indication was received. As noted above, the identified operation may define one or more completion conditions that are evaluated at determination 310. While example determinations are described, it will be appreciated that any of a variety of alternative or additional determinations may be used in other examples. For instance, determination 310 may comprise determining whether user input indicates that the operation is complete.

If it is determined that the operation is not complete, flow branches “NO” to determination 312, where it is determined whether a timeout threshold is exceeded. In other examples, determination 312 comprises evaluating whether the indication that was received at operation 308 is a failure indication. As noted above, the identified operation may define one or more thresholds that are evaluated at determination 312. Similar to determination 310, it will be appreciated that any of a variety of additional or alternative determinations may be made at determination 312.

Accordingly, if it is determined that the threshold has been exceeded, flow branches “YES” to operation 314, where an issue indication is generated. In examples, operation 314 comprises generating an alert at an operator device, providing the indication to a brewing platform, and/or providing the indication to a user device, among other examples. In some instances, the indication is provided in association with telemetry data from the brewing controller, thereby enabling further diagnosis as to the issue that was encountered. While method 300 is illustrated at terminating at operation 314, it will be appreciated that similar aspects may be used in instances where an issue is resolvable, such that flow instead returns to operation 306 and/or 308 while the operation continues to complete, among other examples.

Returning to determination 312, if it is instead determined that the threshold has not been exceeded, flow instead branches “NO” to operation 308, such that method 300 loops while the operation is being completed by one or more of the brewing components. While method 300 is described with respect to sequentially performing a single operation, it will be appreciated that similar techniques may be used to perform multiple serial and/or parallel suboperations, among other examples. For instance, operation 306 comprises providing multiple commands and/or performing processing associated with a set of suboperations for the identified operation, such that determinations 310 and 312 evaluate the set of suboperations accordingly.

Eventually, at determination 310, it is determined that the operation has completed such that flow branches “YES” to determination 316, where it is determined whether there is a remaining operation for the recipe. If it is determined that there is a remaining operation, flow branches “YES” to operation 304, such that method 300 loops between operations 304-316 to complete the recipe accord to aspects described herein. If, however, if it is instead determined that there is not a remaining operation, flow branches “NO” to operation 318, where a completion indication is generated. In examples, operation 318 comprises generating an alert at an operator device, providing the indication to a brewing platform, and/or providing the indication to a user device, among other examples. Method 300 thus terminates at operation 318.

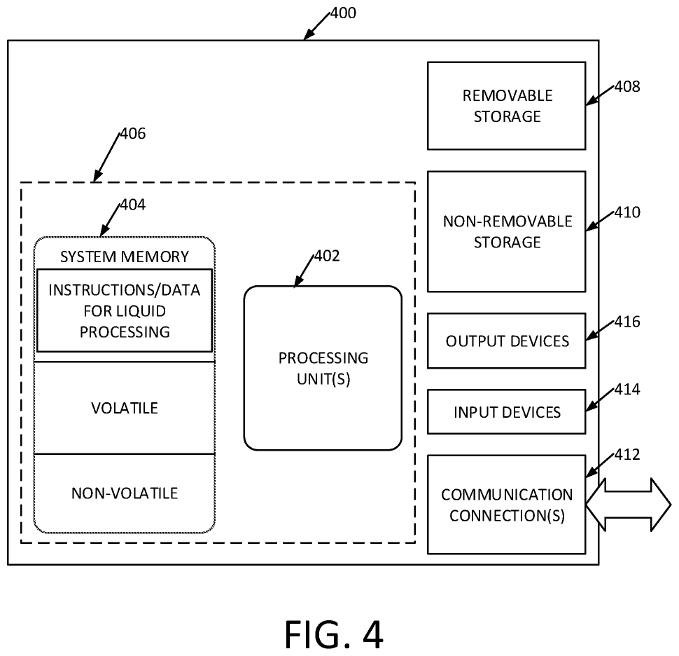

FIG. 4 illustrates an example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically may include at least one processing unit 402 and memory 404. Depending on the exact configuration and type of computing device, memory 404 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as a keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 may include at least some form of computer readable media. The computer readable media may be any available media that can be accessed by processing unit 402 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules (e.g., applications, Input/Output (I/O) management, and other utilities) may perform processes including, but not limited to, one or more of the stages of the operational methods described herein such as the methods illustrated in FIGS. 2 and 3, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The following clauses are provided as example aspects of the disclosed subject matter:
1. A brewing system comprising: at least one processor; and memory storing instructions that, when executed by the at least one processor, causes the system to perform a set of operations, the set of operations comprising: obtaining, from a brewing platform, a recipe comprising a set of operations to produce a liquid; processing an operation of the set of operations to provide, to a brewing controller of the brewing system, a command; receiving, from the brewing controller, telemetry data corresponding to the command; determining, based on the telemetry data, whether the operation is complete; and based on determining the operation is complete, generating an indication that the brewing system has processed the recipe.
2. The brewing system of clause 1, wherein the command provided to the brewing controller is a command to control at least one brewing component of the brewing system.
3. The brewing system of clause 2, wherein the at least one brewing component includes at least one of a heater of the brewing system, a chiller of the brewing system, or a pump of the brewing system.
4. The brewing system of clause 1, wherein determining the operation is complete comprises evaluating the telemetry data based on a completion condition defined by the recipe in association with the operation.
5. The brewing system of clause 1, wherein the telemetry data includes sensor data from a set of sensors of the brewing system.
6. The brewing system of clause 5, wherein the set of sensors includes one or more of: a temperature sensor; a fluid level sensor; a flow sensor; a hydrometer; or a pressure sensor.
7. The brewing system of clause 1, wherein: the operation is a first operation; a second operation of the set of operations includes a manual instruction for a user to perform an action; and the set of operations further comprises: processing the second operation of the set of operations by: presenting the manual instruction to the user; and receiving user input indicating the action has been completed.
8. The brewing system of clause 7, wherein presenting the manual instruction comprises at least one of: displaying the manual instruction at an operator device of the brewing system; or providing the manual instruction for display at a user device.
9. The brewing system of clause 7, wherein the set of operations further comprises evaluating sensor data of the brewing system to determine the action has been completed.
10. The brewing system of clause 1, wherein the set of operations further comprises: determining, based on the telemetry data, whether a timeout threshold is met; and based on determining the timeout threshold is met, generating a failure indication.
11. A method for an automated brewing system, the method comprising: obtaining a recipe comprising a set of operations to cause a set of components of the automated brewing system to produce a liquid; for each operation of the set of operations: generating, based on the operation, a command to control the set of components of the automated brewing system; and determining, based on telemetry data of the automated brewing system, that the operation is complete; and generating an indication that the automated brewing system has produced the liquid.
12. The method of clause 11, wherein: the set of components of the automated brewing system include a heater, a chiller, and a pump; and each generated command corresponds to a set of commands that is implemented by a brewing controller of the automated brewing system.
13. The method of clause 11, wherein the telemetry data includes sensor data from one or more of: a temperature sensor of the automated brewing system; a fluid level sensor of the automated brewing system; a flow sensor of the automated brewing system; a hydrometer of the automated brewing system; or a pressure sensor of the automated brewing system.
14. The method of clause 11, wherein the recipe is obtained from a brewing platform, and the indication is provided to the brewing platform for relay to a user computing device.
15. A method for an automated brewing system, the method comprising: obtaining, from a brewing platform, a recipe comprising a set of operations to produce a liquid; generating, based on an operation of the set of operations, a command to control at least one brewing component of a brewing system; providing, to a brewing controller, the generated command; receiving, from the brewing controller, telemetry data corresponding to the command; determining, based on the telemetry data, whether the operation is complete; and based on determining the operation is complete, generating an indication that the brewing system has processed the recipe.
16. The method of clause 15, wherein the at least one brewing component includes at least one of a heater, a chiller, or a pump.
17. The method of clause 15, wherein determining the operation is complete comprises evaluating the telemetry data based on a completion condition defined by the recipe in association with the operation.
18. The method of clause 15, wherein the telemetry data includes sensor data from one or more of: a temperature sensor; a fluid level sensor; a flow sensor; a hydrometer; or a pressure sensor.
19. The method of clause 15, wherein: the operation is a first operation; a second operation of the set of operations includes a manual instruction for a user to perform an action; and the method further comprises: processing the second operation of the set of operations by: presenting the manual instruction to the user; and receiving user input indicating the action has been completed.
20. The method of clause 19, further comprising evaluating sensor data of the brewing system to determine the action has been completed.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A brewing system comprising:
at least one processor; and
memory storing instructions that, when executed by the at least one processor, causes the system to perform a set of operations, the set of operations comprising:
obtaining, from a brewing platform, a recipe comprising a set of operations to produce a liquid;
processing an operation of the set of operations to provide, to a brewing controller of the brewing system, a command;
receiving, from the brewing controller, telemetry data corresponding to the command;
determining, based on the telemetry data, whether the operation is complete; and
based on determining the operation is complete, generating an indication that the brewing system has processed the recipe.

2. The brewing system of claim 1, wherein the command provided to the brewing controller is a command to control at least one brewing component of the brewing system.

3. The brewing system of claim 2, wherein the at least one brewing component includes at least one of a heater of the brewing system, a chiller of the brewing system, or a pump of the brewing system.

4. The brewing system of claim 1, wherein determining the operation is complete comprises evaluating the telemetry data based on a completion condition defined by the recipe in association with the operation.

5. The brewing system of claim 1, wherein the telemetry data includes sensor data from a set of sensors of the brewing system.

6. The brewing system of claim 5, wherein the set of sensors includes one or more of:
a temperature sensor;
a fluid level sensor;
a flow sensor;
a hydrometer; or
a pressure sensor.

7. The brewing system of claim 1, wherein:
the operation is a first operation;
a second operation of the set of operations includes a manual instruction for a user to perform an action; and
the set of operations further comprises:
processing the second operation of the set of operations by:
presenting the manual instruction to the user; and
receiving user input indicating the action has been completed.

8. The brewing system of claim 7, wherein presenting the manual instruction comprises at least one of:
displaying the manual instruction at an operator device of the brewing system; or
providing the manual instruction for display at a user device.

9. The brewing system of claim 7, wherein the set of operations further comprises evaluating sensor data of the brewing system to determine the action has been completed.

10. The brewing system of claim 1, wherein the set of operations further comprises:
determining, based on the telemetry data, whether a timeout threshold is met; and
based on determining the timeout threshold is met, generating a failure indication.

11. A method for an automated brewing system, the method comprising:
obtaining a recipe comprising a set of operations to cause a set of components of the automated brewing system to produce a liquid;
for each operation of the set of operations:
generating, based on the operation, a command to control the set of components of the automated brewing system; and
determining, based on telemetry data of the automated brewing system, that the operation is complete; and
generating an indication that the automated brewing system has produced the liquid.

12. The method of claim 11, wherein:
the set of components of the automated brewing system include a heater, a chiller, and a pump; and
each generated command corresponds to a set of commands that is implemented by a brewing controller of the automated brewing system.

13. The method of claim 11, wherein the telemetry data includes sensor data from one or more of:
a temperature sensor of the automated brewing system;
a fluid level sensor of the automated brewing system;
a flow sensor of the automated brewing system;
a hydrometer of the automated brewing system; or
a pressure sensor of the automated brewing system.

14. The method of claim 11, wherein the recipe is obtained from a brewing platform, and the indication is provided to the brewing platform for relay to a user computing device.

15. A method for an automated brewing system, the method comprising:
obtaining, from a brewing platform, a recipe comprising a set of operations to produce a liquid;
generating, based on an operation of the set of operations, a command to control at least one brewing component of a brewing system;
providing, to a brewing controller, the generated command;
receiving, from the brewing controller, telemetry data corresponding to the command;
determining, based on the telemetry data, whether the operation is complete; and
based on determining the operation is complete, generating an indication that the brewing system has processed the recipe.

16. The method of claim 15, wherein the at least one brewing component includes at least one of a heater, a chiller, or a pump.

17. The method of claim 15, wherein determining the operation is complete comprises evaluating the telemetry data based on a completion condition defined by the recipe in association with the operation.

18. The method of claim 15, wherein the telemetry data includes sensor data from one or more of:
a temperature sensor;
a fluid level sensor;
a flow sensor;
a hydrometer; or
a pressure sensor.

19. The method of claim 15, wherein:
the operation is a first operation;
a second operation of the set of operations includes a manual instruction for a user to perform an action; and
the method further comprises:
processing the second operation of the set of operations by:
presenting the manual instruction to the user; and
receiving user input indicating the action has been completed.

20. The method of claim 19, further comprising evaluating sensor data of the brewing system to determine the action has been completed.
